(19) United States
(12) Patent Application Publication
(10) Pub. No.: US 2016/0282900 A1
(43) Pub. Date: Sep. 29, 2016

(54) FRAME HAVING COMPONENTS INTEGRATED THEREIN

(71) Applicant: T1V, INC., Charlotte, NC (US)

(72) Inventors: Ronald A. LEVAC, Mount Airy, NC (US); Kevin KELLY, Amherst, NY (US); Mark WILKINS, Amherst, NY (US); James E. MORRIS, Lake Wylie, SC (US); Michael R. FELDMAN, Huntersville, NC (US)

(21) Appl. No.: 15/079,682

(22) Filed: Mar. 24, 2016

Related U.S. Application Data
(60) Provisional application No. 62/137,622, filed on Mar. 24, 2015.

(51) Int. Cl. G06F 1/16

(52) U.S. Cl. CPC G06F 1/1605

(57) ABSTRACT

A frame to be mounted on a separate display, the frame including a bezel and a camera mounted in the bezel.

### CROSS-REFERENCE TO RELATED APPLICATION

The present application claims priority under 35 U.S.C. §119(e) to U.S. Provisional Application No. 62/137,622, filed on Mar. 24, 2016, and entitled: “Frame Having Components Integrated Therein,” which is incorporated herein by reference in its entirety.

### SUMMARY

One or more embodiments is directed to a frame to be mounted on a separate display, the frame including a bezel and a camera mounted in the bezel.

The frame may include analytics hardware mounted in the bezel.

The frame may include a media player mounted in the bezel.

The media player and the analytics hardware may be integrated or may be separate.

The frame may include additional cameras mounted in the bezel.

The frame may include a touch overlay within the bezel.

### BRIEF DESCRIPTION OF THE DRAWINGS

Features will become apparent to those of ordinary skill in the art by describing in detail exemplary embodiments with reference to the attached drawings in which:

FIG. 1 illustrates a schematic diagram of a frame according to a first embodiment;

FIG. 2 illustrates a schematic diagram of a frame according to a second embodiment;

FIG. 3 illustrates a schematic diagram of a frame according to a third embodiment;

FIG. 4 illustrates a schematic diagram of a frame according to a fourth embodiment; and

FIG. 5 illustrates a schematic diagram of a frame according to a fifth embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

The Intellisense™ digital solutions by Cenique™ USA (now part of T1V™,

Inc.) can, from a video stream from a camera, determine the number of people within view of a camera, detect faces, detect gender (male or female), approximate age, and whether or not the person is looking at the camera. If the camera is near a display, it is assumed that the person is looking at the display. Intellisense™ digital solutions can also measure dwell time, i.e., how long a person looks at a display. This gives a measure of how interested people are in the media presented. From the size of the face, Intellisense™ digital solutions can tell how far away each person is from the display. Thus, different images on the display and see how effective these images are for different target audiences may be tracked for different target audiences.

Currently, Intellisense™ digital solutions are sold on hardware for performing the above noted analytics. However, camera acquisition and installation is left to the end user, may move, may not be mounted properly, and may be readily apparent to people. Further, placement of the hardware is left to the end user. Both of these make installation more tedious for the end user.

Therefore, is accordance with one or more embodiments, a frame including a separate bezel to be mated to an existing display that has a camera incorporated therein may insure proper placement of the camera, disguise the presence of the camera, and allow retrofitting of existing displays.

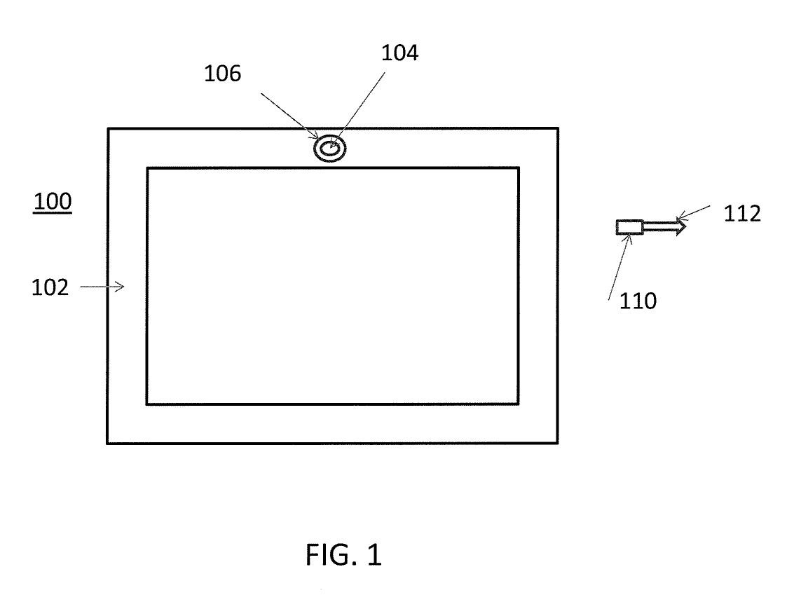

FIG. 1 illustrates a frame 100 according to a first embodiment. The frame 100 includes a bezel 102, which may be an opaque material or any material suitable for achieving an integrated look with a particular display, and a camera 104 in a housing 106 integrated therein. The bezel 102 and the housing 106 for the camera 104 may be matched to minimize the apparent presence of the camera 104. Analytics hardware 110 for performing one or more of the above analyses may be external to the bezel 102 and in communication with the camera 104. The analytics hardware 110 may include an output 112 to connect to a primary computer or may upload data to the cloud.

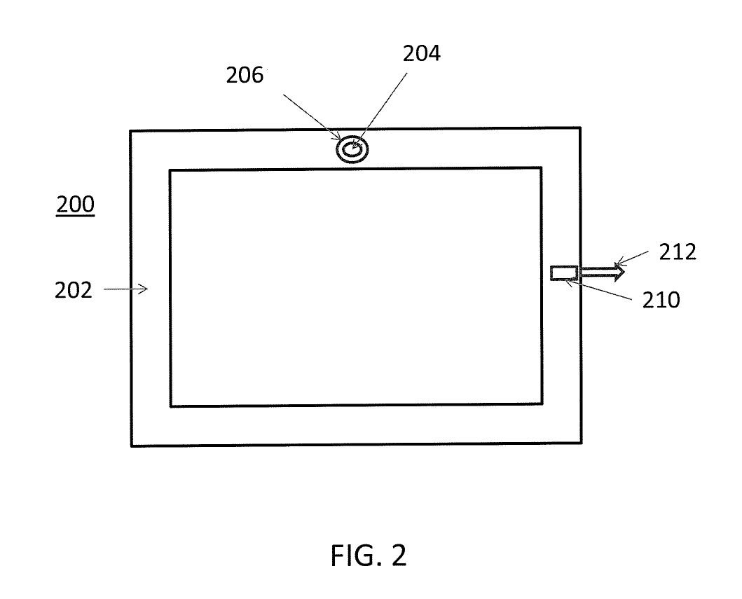

FIG. 2 illustrates a frame 200 according to a second embodiment. The frame 200 includes a bezel 202, which may be an opaque material or any material suitable for achieving an integrated look with a particular display, and a camera 204 in a housing 206 integrated therein. The bezel 202 and the housing 206 for the camera 204 may be matched to minimize the apparent presence of the camera 204. Analytics hardware 210 for performing one or more of the above analyses may be external to the bezel 202 and in communication with the camera 204. The analytics hardware 210 may include an output 212 to connect to a primary computer or may upload data to the cloud.

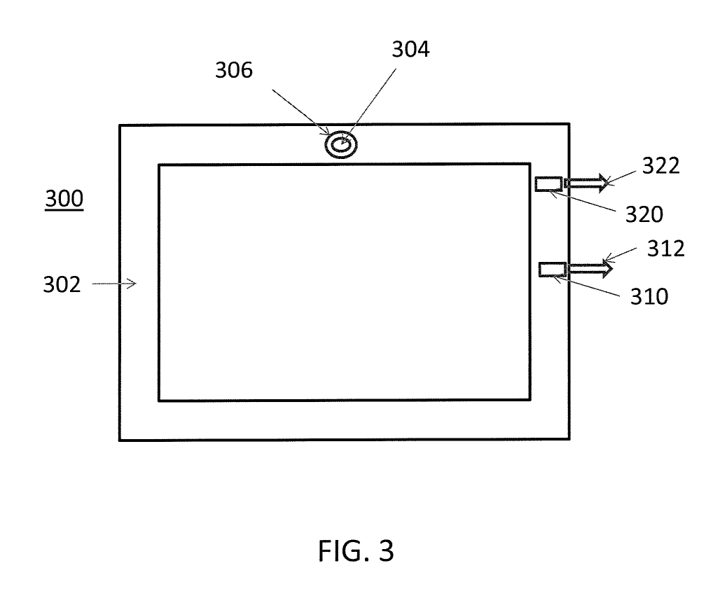

FIG. 3 illustrates a frame 300 according to a third embodiment. The frame 300 includes a bezel 302, which may be an opaque material or any material suitable for achieving an integrated look with a particular display, and a camera 304 in a housing 306 integrated therein. The bezel 302 and the housing 306 for the camera 304 may be matched to minimize the apparent presence of the camera 304. Analytics hardware 310 for performing one or more of the above analyses may also be integrated into the bezel 302. The analytics hardware 310 may include an output 312 to connect to a primary computer or may upload data to the cloud. The frame 300 may also include a media player 220 integrated therein with an output 322 to the display.

In this embodiment, the media player 320 and the analytics software 310 may be in communication, so the media player 320 may change content displayed on the display in accordance with an analysis output from the analytics software 310. Alternatively, the software in the analytics hardware 310 may be incorporated into the media player 320. To control the media that is displayed with the media player 320, Content Management System (CMS) that creates playlists for the media player 320 may be used. The CMS typically runs on a remote computer and updates the playlist on a cloud server. Then from the cloud, media to the primary computer for each display may be synchronized.

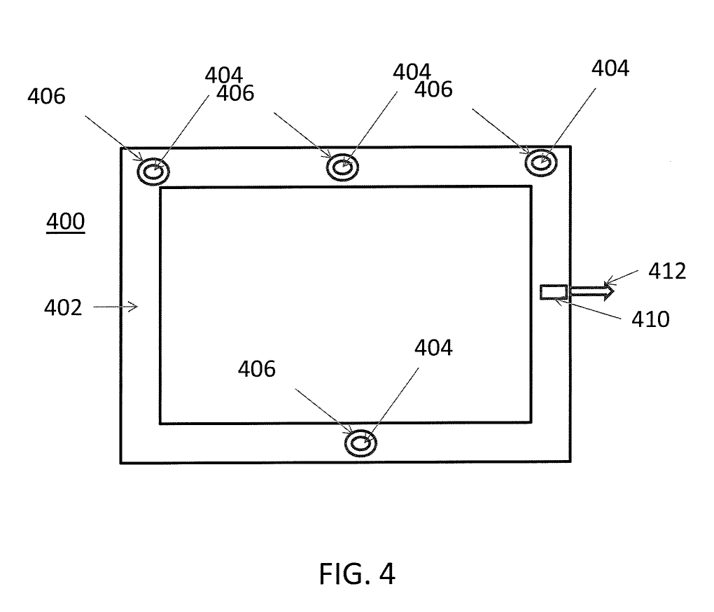

FIG. 4 illustrates a frame 400 according to a fourth embodiment. The frame 400 includes a bezel 402, which may be an opaque material or any material suitable for achieving an integrated look with a particular display, and a camera 404 in a housing 406 integrated therein. The bezel 402 and the housing 406 for the camera 404 may be matched to minimize the apparent presence of the camera 404. Analytics hardware 410 for performing one or more of the above analyses may also be integrated into the bezel 402. The analytics hardware 410 may include an output 412 to connect to a primary computer or may upload data to the cloud. In this embodiment, the frame 400 may also include multiple cameras 404, allowing enhancement for the analysis to be realized, e.g., by detecting proximity more accurately, but without requiring additional work on the part of the end user. Further, the use of multiple cameras 404 with large screen allows different on different sections or areas of the display. Additionally, some cameras may be used for people close to the display and other cameras for people further away. Additionally, one camera could be mounted higher and angled differently than other cameras to determine a number of people, while another camera could be used for facial detection.

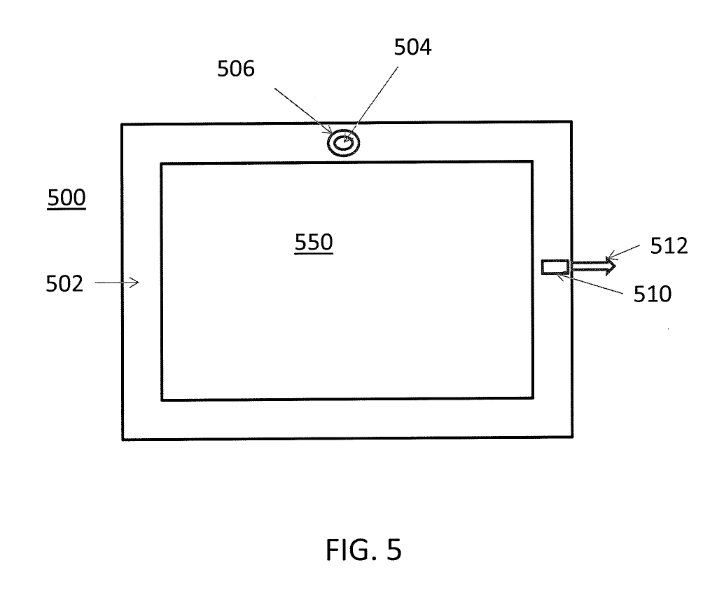

FIG. 5 illustrates a frame 500 according to a fifth embodiment. The frame 500 includes a bezel 502, which may be an opaque material or any material suitable for achieving an integrated look with a particular display, and a camera 504 in a housing 506 integrated therein. The bezel 502 and the housing 506 for the camera 504 may be matched to minimize the apparent presence of the camera 504. Analytics hardware 510 for performing one or more of the above analyses may also be integrated into the bezel 502. The analytics hardware 510 may include an output 512 to connect to a primary computer. Here, the frame 500 also includes a touch overlay 550 that allows the display to which the frame is to be attached to accept touch inputs, as sold, for example, by u-touch.

The frames noted above may be designed for a specific display or may be adjustable for a range of display sizes and manufacturers. The camera could be very small and embedded in the frame, so that once mounted to the display, the camera would be essentially invisible to a user standing a few feet away from the display. The bezel would be thick enough (z-axis) and wide enough to accommodate all components to be integrated therein.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A frame to be mounted on a separate display, the frame comprising:
a bezel; and
a camera mounted in the bezel.

2. The frame as claimed in claim 1, further comprising analytics hardware mounted in the bezel.

3. The frame as claimed in claim 2, further comprising a media player mounted in the bezel.

4. The frame as claimed in claim 3, wherein the media player and the analytics hardware are integrated.

5. The frame as claimed in claim 3, wherein the media player and the analytics hardware are separate.

6. The frame as claimed in claim 3, further comprising additional cameras mounted in the bezel.

7. The frame as claimed in claim 6, further comprising a touch overlay within the bezel.

8. The frame as claimed in claim 1, further comprising additional cameras mounted in the bezel.
